(19) United States
(12) Patent Application Publication
(10) Pub. No.: US 2009/0276853 A1
(43) Pub. Date: Nov. 5, 2009

(54) FILTERING INTRUSION DETECTION SYSTEM EVENTS ON A SINGLE HOST

(75) Inventor: Sudhakar GOVINDAVAJHALA, Edison, NJ (US)

Correspondence Address: Sudhakar Govindavajhala;Brain League IP Services, 2570 N 1st Street, Second Floor, San Jose, CA, 94024, US

(73) Assignee: MULVAL TECHNOLOGIES, INC., Edison, NJ (US)

(21) Appl. No.: 12/114,040

(22) Filed: May 2, 2008

(51) Int. Cl. G06F 12/14

(52) U.S. Cl. 726/23

(57) ABSTRACT

Embodiments disclosed herein describe a method to determine consequences of a privilege escalation alert from an intrusion detection system, the method comprising the steps of obtaining privilege escalation alert from the intrusion detection system and analyzing said privilege escalation alert information. The analysis further comprises of identifying the program affected by said privilege escalation alert and determining if it can be circumvented. The users affected by said privilege escalation alert and the transitive effects of said privilege escalation alert are identified.

### BACKGROUND

1. Technical Field

The embodiments herein generally relate to network management, and, more particularly, to determining the effects of a privilege escalation alert and identifying appropriate response measures.

2. Description of the Related Art

Snort is widely used, open-source software that monitors network packets and identifies attempted privilege escalations on a computer network or on a single host running an exemplary Operating System (Windows XP/Visyta/2000,2003, Red Hat Linux, Solaris, HP-UX, etc.). Snort detection system identifies that an attempt is made to circumvent a program that takes input from network by listening on a particular port. Snort provides information about the source of the attempt, and the targeted program port and host identification. There are multiple intrusion detection systems available in the market that have above property. They include ISS Intrusion Product, Snort, and other network and host-based intrusion detection products. The usage of Snort for intrusion detection and Windows operating system in this patent is used only as an example; those skilled in the art will be able to see that the same principles can be applied to other operating systems and intrusion detection systems.

For example, consider a host operating system Windows XP Service Pack 2 Version 5.1 and Snort Version 2.7.0. On detecting a TCP escalation attempt from IP 128.112.155.165, port 55749 to host 128.112.104.155 port 135, the sample output of Snort is 08/20-22:04:29.626727 [**] [1:268:0] worm [**] [Priority: 0] {TCP} 128.112.155.165:55749 −>128.112.104.155:135. The message “Worm” is an information message defined in the Snort configuration. But snort alerts miss certain information though the raw data is useful for a single host to be used by an expert.

A recurring weakness of intrusion detection systems is their high false-positive rate. It is quite common that intrusion detection systems output tens of thousands and hundreds of alerts; many of these alerts are false positives. It requires tremendous human observation to manually observe each alert.

Snort alerts do not provide information about the program being targeted. Some programs are more robust and can resist malicious attempts better than others. For example, sendmail SMTP server is considered extremely risky based on the history of problems. In contrast, Postfix SMTP server is considered robust and invulnerable to malicious attempts. Both the server programs perform the same task, run on the same operating system and on the same port. But it is not possible to identify the risk in the attempted escalation by looking at the snort alert because the alert does not provide any information regarding the program.

Also, Snort alerts do not provide information on whether a program can indeed be circumvented on reception of an alert. The success of the attempted escalation using a program depends on the version of the program. Current IDS systems only provide information on which port is being targeted and hence is not possible to distinguish between two different attempts, where one attempt goes to a vulnerable server and another goes to an invulnerable server.

Furthermore, Snort alerts do not provide information on the user account under which a program is running based on an alert. It is common to find that a server program runs under different user accounts in different network hosts. For example, on one machine, a SSHD server may run as “sshd” user, and on other servers, the program might run under an administrative account or the like. A snort alert for an administrative account is more important than a Snort alert for a non-administrative account. The priority of the alert can be determined as high or low by identifying which user is affected by the alert. If an administrative account is affected, then the alert is of higher priority. The ability to recognize the user may be useful for identifying other privilege escalations that occur from the targeted user. But, Snort does not provide information about the user account that is being targeted.

Furthermore, Snort alerts do not provide information on transitive effects of the alerts. In a case, a Snort alert hits “Generic Host Services for Win32” program running as NetworkService (non-administrative account) on port 135. The Snort alert does not provide information that it is possible to take control of the administrative account LocalSystem indirectly because of the existing path from NetworkService to LocalSystem. Hence it is not possible to incorporate information like current background scans and attempted escalations into the framework to analyze current risk profile.

### SUMMARY

In view of the foregoing, an embodiment herein provides a method and a program storage device readable by computer, tangibly embodying a program of instructions executable by the computer to perform a method to determine consequences of a privilege escalation alert from Snort, the method comprising the steps of obtaining privilege escalation alert from Snort; and analyzing the privilege escalation alert information to determine port targeted, using appropriate tools (such as netstat) to determine the program affected by the privilege escalation alert; identifying if the affected program identified can be circumvented, the user affected by said privilege escalation alert; and transitive effects of the privilege escalation alert. The privilege escalation alert is ignored if said affected program cannot be circumvented. The privilege escalation can be ignored if it is determined that the particular network packet does not have the ability to attack the program. Determining the program affected by the privilege escalation comprises of determining process identifier of process of the program and determining identifying information including process identifier of process of the program. Determining if the affected program identified can be circumvented comprises of verifying vulnerability status of the affected program using external tools (Qualys, eEye Retina scanner, IBM ISS scanner) and verifying vulnerability status of the affected program from one or more databases. These program vulnerability information databases could be built by consulting appropriate mailing lists or otherwise. The step of determining user affected by the privilege escalation detected further comprises of determining identifying information including process identifier of process of the program affected; and determining user account that is running the process. The step of determining transitive effects of the privilege escalation detected further comprises of determining all user accounts that could be compromised after successfully compromising the affected program. The step of determining transitive effects of the privilege escalation detected further comprises of determining identifying information including process identifier of process of the program affected; determining user account that is running the process; determining further escalations from the user to other users; and determining all user accounts that could be compromised after successfully compromising the program affected. The method further comprises of triaging alerts privilege escalation alerts based on one or more of the criteria of vulnerability status of the program targeted; program affected; user account of the program affected; and user accounts that could be compromised after successfully compromising the program affected.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates the network complexity in an example network having multiple hosts with multiple operating systems;

FIG. 2 illustrates a flowchart depicting broadly a method of determining consequences based on privilege escalation alerts from intrusion detection systems according to embodiments disclosed herein; and

FIG. 3 illustrates a flowchart depicting a method of determining consequences according to embodiments disclosed herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

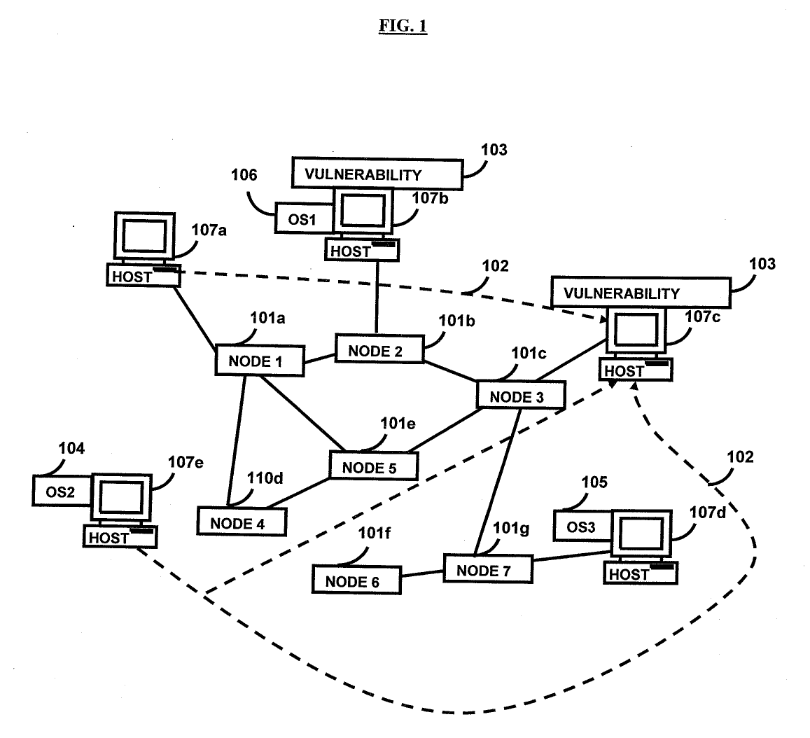

The embodiments herein achieve a method to determine consequences based on privilege escalation alerts provided by intrusion detection systems like Snort. Referring now to the drawings, and more particularly to FIGS. 1 through 3, where similar reference characters denote corresponding features consistently throughout the figures, there are shown preferred embodiments.

FIG. 1 illustrates a sample network comprising of plurality of hosts 107a-e connected to each other by plurality of network nodes 101a-g. The hosts 107b and 107c are vulnerable 103 to attacks as indicated in the figure. The hosts 107a-e operate on various operating systems 104, 105 and 106 as shown in the figure.

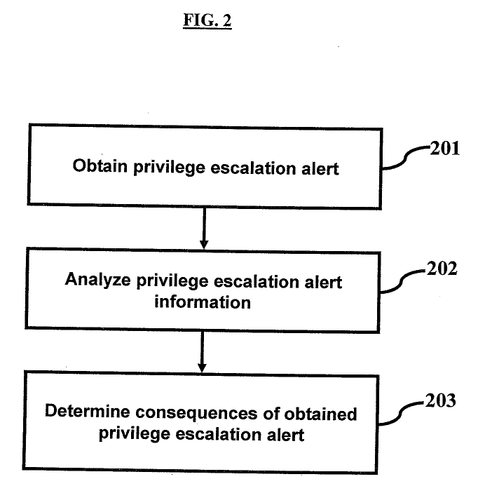

FIG. 2 shows the evaluation and analysis of a privilege escalation alert. The privilege escalation alert is received (201), analyzed (202) and the consequence is determined (203). The analysis and resulting action due to the privilege escalation alert is described by the various embodiments described herein.

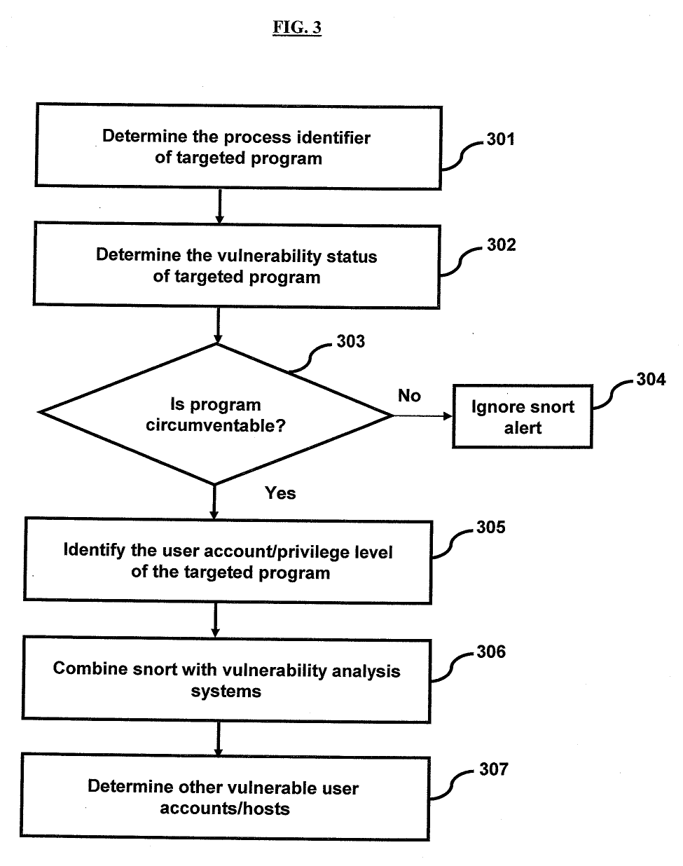

FIG. 3 shows the evaluation of the risks of the privilege escalation alert. The process identifier of the targeted program is determined (301) and the vulnerability status is determined (302). The vulnerability of the program to be circumvented is examined (303) and ignored if the program cannot be circumvented (304) else the user account and privilege level of the targeted program is identified (305). The vulnerability analysis system is combined with snort (306) and other vulnerable user account and hosts are identified (307).

In an embodiment disclosed herein the vulnerability of the target program in a host is determined. The affect of the attack on the program is dependent on the robustness of the program to resist malicious attempts and independent of task performed, port and operating system. The process identifier used by the operating system kernel to uniquely identifies the program and hence its vulnerability to attempted escalation is extracted using appropriate tools and programs, for example, Netstat. Further, the tools and programs extract other relevant information of the program to evaluate the risk involved for the program.

In an embodiment the vulnerability of a system for attacks is determined by evaluating if the program can be circumvented. The existence of vulnerabilities is recognized by using various tools which includes consulting mailing lists such as BugTraq. The Snort alert is analyzed if the program can be circumvented and ignored if the program is robust and cannot be bypassed.

In an embodiment disclosed herein the user account using the target port is determined to prioritize the Snort alert. The user account is evaluated using appropriate operating specific methods which include Process Explorer or Task Manager or operating system functions such as CreateToolhelp32Snapshot, and the priority of the alert is determined accordingly.

In an embodiment disclosed herein further escalations from the targeted user to other user is identified to evaluate the transitive effects of a snort alert. Analyzer tools which include the multi-host multi-stage vulnerability analyzer (MMVA) as described in application Ser. No. 11/699,607 can be used in conjunction with the Snort alert to determine user accounts which are vulnerable to escalation attempts.

The embodiments disclosed herein can take the form of an entirely hardware embodiment, an entirely software embodiment or an embodiment including both hardware and software elements. The embodiments that are implemented in software include but are not limited to, firmware, resident software, microcode, etc.

Furthermore, the embodiments disclosed herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A method to determine consequences of a privilege escalation alert from an intrusion detection systems, the method comprising the steps of:
a. obtaining privilege escalation alert from said intrusion detection system; and
b. analyzing said privilege escalation alert information to determine:
i. program affected by said privilege escalation alert;
ii. if said affected program identified can be circumvented;
iii. users affected by said privilege escalation alert; and
iv. transitive effects of said privilege escalation alert.

2. The method of claim 1, the method further comprising ignoring said privilege escalation alert if said affected program cannot be circumvented.

3. The method of claim 1, wherein the step of determining program affected by said privilege escalation detected further comprises of determining process identifier of process of said program.

4. The method of claim 1, wherein the step of determining program affected by said privilege escalation detected further comprises of determining identifying information including process identifier of process of said program.

5. The method of claim 1, wherein the step of determining if said affected program identified can be circumvented further comprises of verifying vulnerability status of said affected program using external tools.

6. The method of claim 1, wherein the step of determining if said affected program identified can be circumvented further comprises of verifying vulnerability status of said affected program from one or more databases, where a database is a compilation of information from mailing lists discussing said affected program vulnerability information.

7. The method of claim 1, wherein the step of determining if said affected program identified can be circumvented further comprises of verifying vulnerability status of said affected program from one or more databases, where a database is a database comprising list of vulnerable programs on specific ports.

8. The method of claim 1, wherein the step of determining user affected by said privilege escalation detected further comprises of:
a. determining identifying information including process identifier of process of said program affected; and
b. determining user account that is running said process.

9. The method of claim 1, wherein the step of determining transitive effects of said privilege escalation detected further comprises of determining all user accounts that could be compromised after successfully compromising said affected program.

10. The method of claim 1, wherein the step of determining transitive effects of said privilege escalation detected further comprises of:
a. determining identifying information including process identifier of process of said program affected;
b. determining user account that is running said process;
c. determining further escalations from said user to other users and groups; and
d. determining all user accounts that could be compromised after successfully compromising said program affected.

11. The method of claim 1, the method further comprising triaging alerts privilege escalation alerts based on one or more of the criteria of:
a. vulnerability status of the program targeted;
b. program affected;
c. user account of said program affected; and
d. user accounts that could be compromised after successfully compromising said program affected.

12. A program storage device readable by computer, tangibly embodying a program of instructions executable by said computer to perform a method of determining consequences of a privilege escalation alert from an intrusion detection system, the method comprising the steps of:
a. obtaining privilege escalation alert from said intrusion detection system; and
b. analyzing said privilege escalation alert information to determine:
i. program affected by said privilege escalation alert;
ii. if said affected program identified can be circumvented;
iii. users affected by said privilege escalation alert; and
iv. transitive effects of said privilege escalation alert.

13. A program storage device readable by computer, as claimed in claim 12, wherein said privilege escalation alert is ignored if said affected program cannot be circumvented.

14. A program storage device readable by computer, as claimed in claim 12 wherein the affected program by said privilege escalation is determined by determining the process identifier of process of said program.

15. A program storage device readable by computer, as claimed in claim 12 wherein the affected program by said privilege escalation is determined by determining the identifying information including process identifier of process of said program.

16. A program storage device readable by computer, as claimed in claim 12 wherein the identified affected program is verified to be circumvented comprises of verifying vulnerability status of said affected program using external tools.

17. A program storage device readable by computer, as claimed in claim 12 wherein the identified affected program is verified to be circumvented comprises of verifying vulnerability status of said affected program from one or more databases, where a database is a compilation of information from mailing lists and other resources discussing said affected program vulnerability information.

18. A program storage device readable by computer, as claimed in claim 12 wherein the identified affected program is verified to be circumvented comprises of verifying vulnerability status of said affected program from one or more databases, where a database is a database comprising list of vulnerable programs on specific ports.

19. A program storage device readable by computer, as claimed in claim 12 wherein the affected user by said privilege escalation is detected where said device comprises of:
a. a means to determine identifying information including process identifier of process of said program affected; and
b. a means to determine user account that is running said process.

20. A program storage device readable by computer, as claimed in claim 12 wherein the transitive effects of said detected privilege escalation comprises of determining all user accounts that could be compromised after successfully compromising said affected program.

21. A program storage device readable by computer, as claimed in claim 12 wherein the transitive effects of said detected privilege escalation further comprises of:
a. a means to determine identifying information including process identifier of process of said program affected;
b. a means to determine user account that is running said process;
c. a means to determine further escalations from said user to other users and groups; and
d. a means to determine all user accounts that could be compromised after successfully compromising said program affected.

22. A program storage device readable by computer, as claimed in claim 12 wherein triaging alerts privilege escalation alerts based on one or more criteria comprising of:
a. vulnerability status of the program targeted;
b. program affected;
c. user account of said program affected; and
d. user accounts that could be compromised after successfully compromising said program affected.
